(19) United States
(12) Patent Application Publication
(10) Pub. No.: US 2024/0358192 A1
(43) Pub. Date: Oct. 31, 2024

(54) Fire Pit Accessory Storage Caddy

(71) Applicant: Breeo, LLC, Kinzers, PA (US)

(72) Inventor: Christopher Boehmer, Shohola, PA (US)

(21) Appl. No.: 18/618,614

(22) Filed: Mar. 27, 2024

Related U.S. Application Data
(60) Provisional application No. 63/462,807, filed on Apr. 28, 2023.

(51) Int. Cl. A47J 37/07

(52) U.S. Cl. CPC A47J 37/0786

(57) ABSTRACT

A storage caddy has spaced side walls that define aligned slots that receive different fire pit accessories such as a cover, one or more grills, a heat deflector, and griddles. The slots are angled rearwardly from vertical so the accessories tip rearwardly. The side walls are taller at the rear of the caddy providing both deeper slots for larger accessories and to provide access to the stored accessories. Additional accessory storage is provided through aligned openings in spaced flanges that project rearwardly from the front wall of the storage caddy.

### CROSS-REFERENCE TO RELATED APPLICATIONS

This application claims the benefit of U.S. Provisional Patent Application No. 63/462,807 filed Apr. 28, 2023; the disclosures of which are incorporated herein by reference.

### BACKGROUND

Outdoor fire pits have long been popular to sit around and enjoy a campfire in one's backyard. Cooking food on outdoor fire pits is increasing in popularity. To fully enjoy a fire pit, many people buy a variety of accessories that are used to store the fire pit, used to cook on the fire pit, and used to deflect the heat from the fire pit. These accessories include a fire pit cover, a heat deflector, an ash shovel, a fire poker, and cooking utensils. As outdoor fire pits become more popular, people look for ways to cook meals using the heat from the fire pit. A variety of cooking utensils have been developed for use with fire pits including large and small grills, large and small sear plates, accessory mounting posts, and rotisseries. Those who own and use these items desire a convenient place to store the items while they are not in use.

### SUMMARY OF THE DISCLOSURE

The disclosure provides a storage caddy for common fire pit accessories. The caddy provides a convenient place to store a plurality of accessories in a compact footprint. The storage caddy is configured to provide access to each accessory without the need for moving others. The storage caddy is stable, heat resistant, and weather resistant.

The disclosure provides a storage caddy having spaced side walls that define aligned slots that receive different fire pit accessories such as a cover, one or more grills, a heat deflector, and griddles. The slots are angled about five degrees rearwardly from vertical so the accessories tip rearwardly. The side walls are taller at the rear of the caddy providing both deeper slots for larger accessories and to provide access to the stored accessories. Additional accessory storage is provided through aligned openings in spaced flanges that project rearwardly from the front wall of the storage caddy.

The disclosure provides a storage caddy having converging side walls such that the width of the front of the caddy is smaller than the width of the rear of the caddy. This allows small items to be stored at the front of the caddy and larger items to be stored at the rear.

The disclosure provides a caddy that is stable when loaded with a plurality of relatively heavy fire pit accessories. The caddy is configured to remain upright when subject to normal accidental contact forces of a person brushing up against the caddy. The caddy achieves this stability by having a rear wall that extends rearwardly from the rear top of the side walls. When viewed from the side, the rear wall is angled forwardly from vertical about fifteen to thirty degrees. The front wall is also angled rearwardly about five to fifteen degrees from vertical to provide pyramidal stability to the caddy.

The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF DRAWINGS

FIG. 1 is a front left perspective view of a first configuration of a fire pit accessory storage caddy.

FIG. 2 is a rear left perspective view of the storage caddy of FIG. 1.

FIG. 3 is a front elevation view thereof.

FIG. 4 is a rear elevation view thereof.

FIG. 5 is a left side elevation view thereof.

FIG. 6 is a front left perspective view of a second configuration of a fire pit accessory storage caddy.

FIG. 7 is a rear left perspective view of the storage caddy of FIG. 6.

FIG. 8 is a front elevation view thereof.

FIG. 9 is a rear elevation view thereof.

FIG. 10 is a left side elevation view thereof.

FIG. 11 is a side view with a grill and a sear plate stored in the second configuration of the storage caddy.

### DETAILED DESCRIPTION OF THE INVENTION

This description of exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

The disclosure provides first and second embodiments of a storage caddy 2 configured to store fire pit accessories. An owner of a single fire pit may also own a fire pit cover, a heat deflector, an ash shovel, a fire poker, and cooking utensils. The cooking utensils can include large and small grills, large and small griddles, accessory mounting posts, and rotisseries. All of these are not used at the same time. For example, the fire pit cover is removed when the fire is initially built. The cooking utensils may then be used. After the food is prepared, the heat deflector may be used. Some of these accessories are hot when removed from the fire pit. Caddy 2 provides a place where all can be stored together where each is individually accessible. Caddy 2 is made from a metal such as stainless steel that allows a hot accessory to be stored and allowed to cool.

Storage caddy 2 includes at least side walls 4, a front wall 6, and a rear wall 8. Storage caddy also can optionally include a top wall or flange 10 and an inner flange 12. Further, storage caddy 2 can optionally include feet 14. All of these pieces are made from a metal such as steel, stainless steel, or aluminum. The pieces are connected directly or indirectly with welds, fasteners, or a combination of both. In the exemplary configurations, the front and rear portions of side walls 4 are bent inwardly to provide tabs 16 to which front 6 and rear 8 walls are connected. When feet 14 are provided, they can be integral with front 6 and rear 8 walls formed from tabs of material bent inwardly. Other manners of connecting side walls 4 and forming feet 14 include using welds without tabs 16 and brackets between the walls.

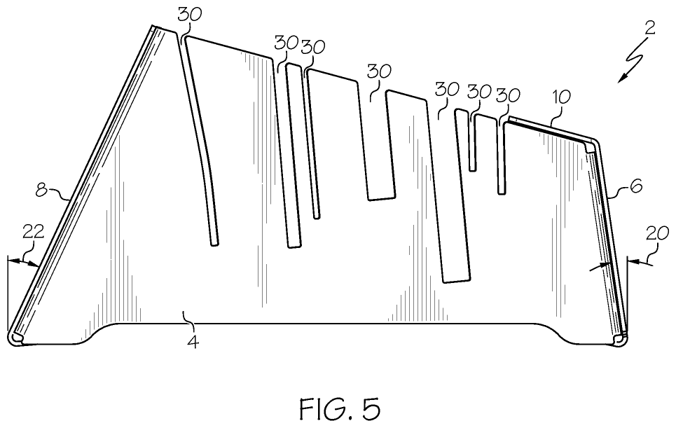

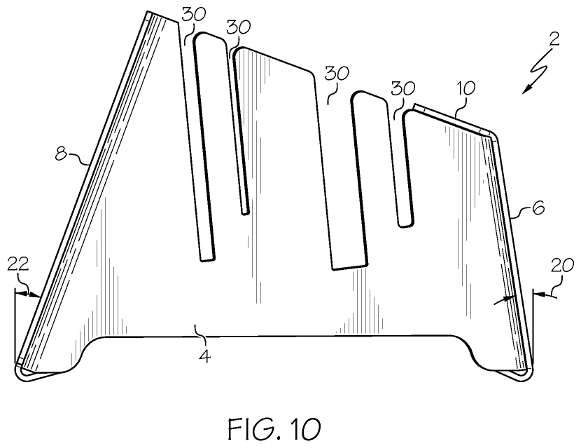

As shown in FIGS. 5 and 10, front wall 6 is angled rearwardly and rear wall 8 is angled forward to provide base to caddy 2 that is longer than its upper edge that receives accessories. Front wall 6 is angled rearwardly from vertical about five to fifteen degrees (angle 20) and rear wall 8 is angled forward about fifteen to thirty degrees (angle 22). Angling front 6 and rear 8 walls in these configurations increases the length of the lower portion of caddy 2 to increase its stability.

The lower edge of each wall 4, 6, and 8 defines an elongated notch which leaves the material at the ends to function as legs for caddy 2. Raising the centers of the walls helps the stability of caddy 2 when it is standing on uneven surfaces.

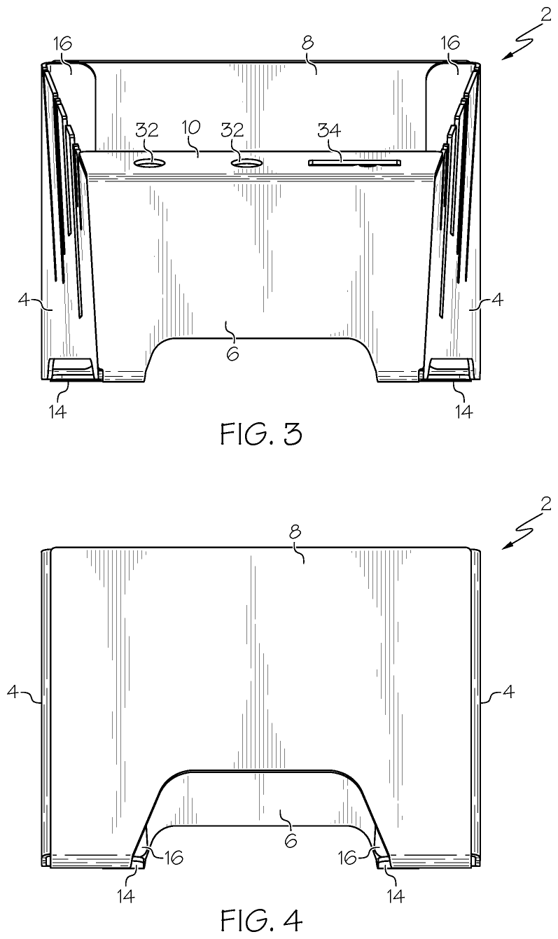

As also shown in FIGS. 5 and 10, rear wall 8 is taller than front wall 6 such that the top edges of side walls 4 slope downwardly from rear wall 8 to front wall 6. As shown in FIGS. 3 and 8, side walls 4 also converge as they move toward front wall 6 because the maximum width of front wall 6 is smaller than the maximum width of rear wall 8. Further, the upper edge of front wall 6 has a width that is larger than the width of the lower edge which causes the front portions of side walls 4 to somewhat taper outwardly for receiving the smaller diameter accessories.

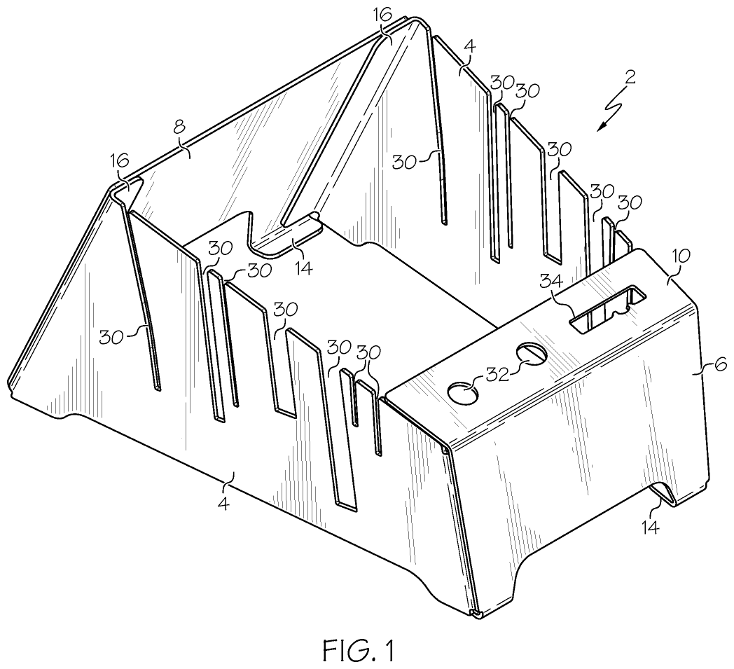

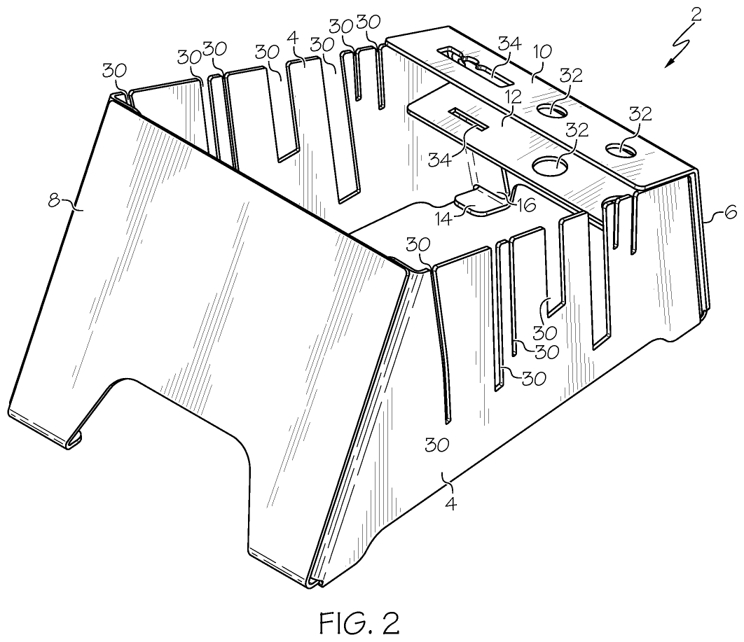

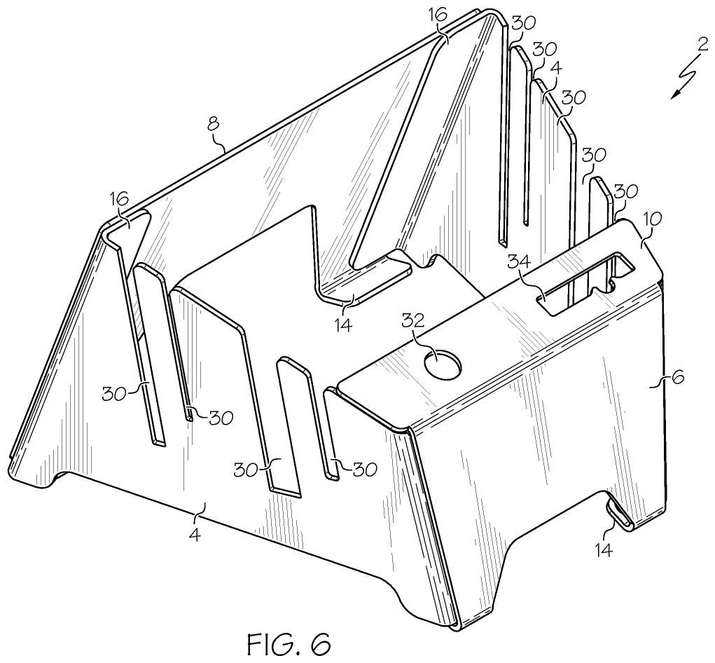

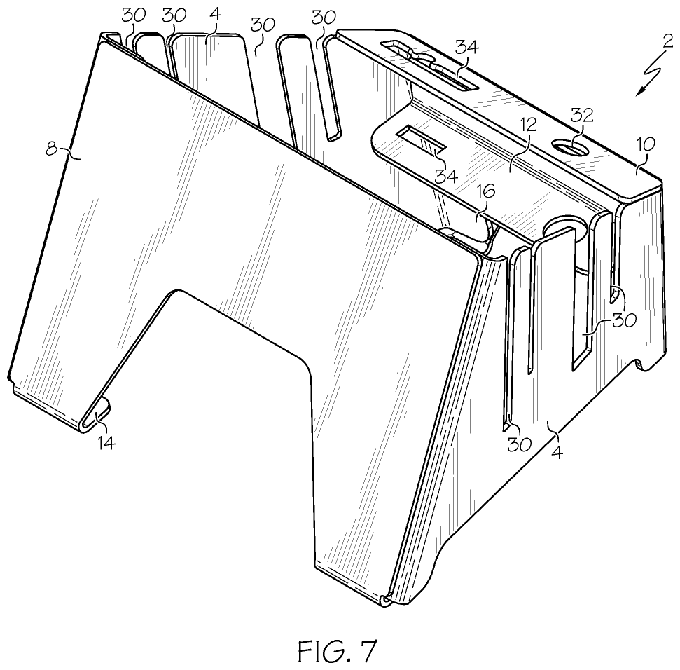

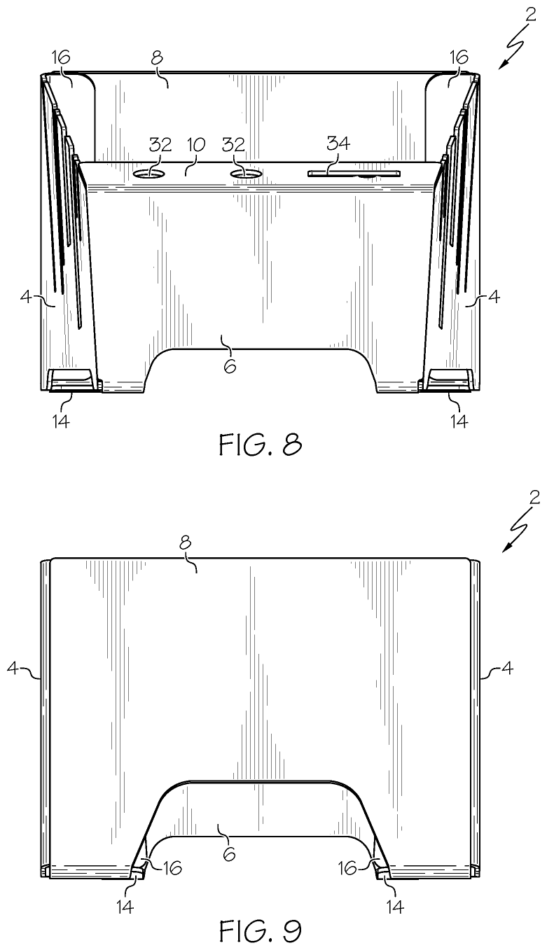

Side walls 4 define at least one pair of laterally aligned mounting slots 30 into which an accessory is placed for storage. Each slot 30 extends into the body of side wall 4 from the upper edge of side wall 4. Slots 30 are angled rearwardly from vertical about one to ten degrees so that the accessory placed in slots 30 is tilted back when stored. In the configuration of FIGS. 1-5, each side wall 4 defines seven slots for receiving seven accessories. In the configuration of FIGS. 6-10, each side wall 4 defines four slots for receiving four accessories. Slots 30 can be the same size and depth or can be sized for different sized accessories.

In the configuration of FIGS. 1-5, the rearmost slot 30 is the longest slot and includes a first portion and a second portion that are not parallel. This rearmost slot is configured to receive the lower flange of a heat deflector that has bent flanges. The next forward set of slots 30 is less deep but wider and is configured to receive a griddle. Continuing forward, the next set of slots 30 are shorter and thinner and are configured for a lid. The next two sets of slots 30 are wider and designed to receive grills. These have different lengths so that the grills are vertically offset and easy to access when both are stored. The final two sets of slots 30 are thinner and short and designed for small griddles. These also have different lengths so that the griddles are vertically offset and easy to access when two are stored together.

In the configuration of FIGS. 6-10, the rearmost slot 30 is the longest slot and is configured to receive a griddle. The next set of slots 30 forward are shorter and thinner and are configured for a lid. The sets of slots 30 are wider and designed to receive a grill. The final set of slots 30 are thinner and short and designed for a small griddle. These also have different lengths so that the griddles are vertically offset and easy to access when two are stored together.

Additional storage areas are provided by top wall 10 and inner flange 12 which define aligned openings. In both configurations, wall 10 and flange 12 define a set of round openings 32 that are sized to receive a grill post and a set of elongated openings 34 that receive a fire poker. The configuration of FIGS. 1-5 defines two sets of round openings 32 for two grill posts.

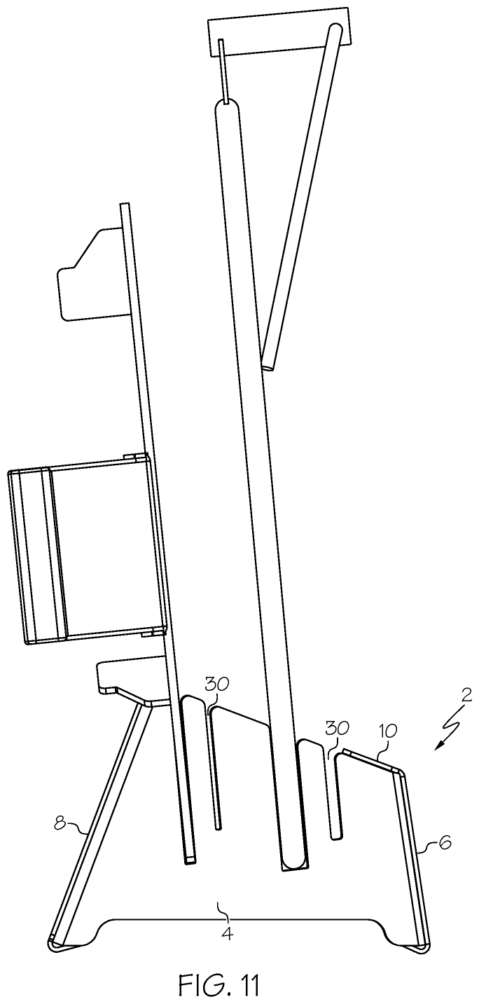

FIG. 11 shows how a sear plate and a grill are stored in the second configuration of the storage caddy.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are examples and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps. Up, down, left, right, top, and bottom are in reference to the orientation of the drawings.

1. A storage caddy for fire pit accessories; the caddy comprising:
first and second side walls; each of the first and second side walls having an upper edge, a lower edge, a front end and a rear end;
a front wall extending between the front ends of the first and second side walls;
a rear wall extending between the rear ends of the first and second side walls;
the first side wall defining a first mounting slot that extends through the upper edge of the first side wall;
the second side wall defining a first mounting slot that extends through the upper edge of the second side wall;
the first mounting slot of the first side wall being laterally aligned with the first mounting slot of the second side wall to define a first pair of laterally aligned mounting slots; and
the first pair of laterally aligned mounting slots adapted to receive a fire pit accessory such that the fire pit accessory is carried by the caddy.

2. The caddy of claim 1, wherein the rear ends of each of the first and second side walls are taller than the front ends of each of the first and second side walls.

3. The caddy of claim 2, wherein the first and second side walls define a second pair of laterally aligned mounting slots located intermediate the rear wall and the first pair of laterally aligned mounting slots; the second pair of laterally aligned mounting slots having a depth that is deeper than a depth of the first pair of laterally aligned mounting slots.

4. The caddy of claim 1, wherein the rear wall is angled forwardly such that a top end of the rear wall is located forward of a bottom end of the rear wall.

5. The caddy of claim 4, wherein the front wall is angled rearwardly such that a top end of the front wall is located rearward of a bottom end of the front wall.

6. The caddy of claim 5, wherein the front wall is angled rearwardly from vertical about five to fifteen degrees and the rear wall is angled forward about fifteen to thirty degrees such.

7. The caddy of claim 1, wherein the front ends of the first and second sidewalls are closer together than the rear ends of the first and second sidewalls.

8. The caddy of claim 1, wherein the first pair of laterally aligned mounting slots is angled rearwardly.

9. The caddy of claim 1, further comprising a top wall that projects rearward from the front wall and an inner flange located below the top wall; the top wall and inner flange defining a first pair of aligned openings adapted to receive a second fire pit accessory.

10. The caddy of claim 9, wherein the top wall and inner flange define a second pair of aligned openings adapted to receive a third fire pit accessory.

11. The caddy of claim 1, further comprising first and second spaced feet at the bottom of the rear wall and first and second spaced feet at the bottom of the front wall.
